(19) United States
(12) Patent Application Publication
(10) Pub. No.: US 2026/0295423 A1
(43) Pub. Date: Oct. 1, 2026

(54) SCENE-AGNOSTIC COORDINATE MODEL FOR DEVICE LOCALIZATION

(71) Applicant: Niantic Spatial, Inc., San Francisco, CA (US)

(72) Inventors: Eric Brachmann, Dresden (DE); Victor Adrian Prisacariu, Oxford (GB); Tommaso Cavallari, Oxford (GB); Axel Barroso-Laguna, Barcelona (ES); Aron Monszpart, London (GB); Leonard Bruns, London (GB); Purna Sowmya Munukutla, Redwood City, CA (US)

(21) Appl. No.: 19/631,229

(22) Filed: Mar. 27, 2026

Related U.S. Application Data
(60) Provisional application No. 63/778,651, filed on Mar. 27, 2025.

(51) Int. Cl. A63F 13/60; G06N 20/00

(52) U.S. Cl. CPC A63F 13/60; G06N 20/00

(57) ABSTRACT

A game server trains and uses a scene-agnostic coordinate model for image localization. The game server accesses mapping buffers containing feature-coordinate pairs that describe images and their spatial locations within scenes. The game server generates map codes that encode scene-specific information by iteratively applying the scene-agnostic coordinate model to predict coordinates and updating the map codes based on computed loss scores. The game server trains the scene-agnostic coordinate model using query buffers through a separate training phase where only model parameters are updated while map codes remain fixed, ensuring the model generalizes across different scenes. The trained model receives images from client devices, generates features, and applies the scene-agnostic coordinate model with appropriate map codes to predict coordinates for localization. The game server uses these predicted coordinates to provide augmented reality content.

### CROSS-REFERENCE TO RELATED APPLICATIONS

This application claims the benefit of U.S. Provisional Patent Application No. 63/778,651, entitled “Scene-Agnostic Coordinate Model for Device Localization” and filed Mar. 27, 2025, which is incorporated by reference.

This application also incorporates by reference U.S. Patent Application No. 18/542,460, entitled “Accelerated Coordinate Encoding: Learning to Relocalize in Minutes using RBG and Poses” and filed December 15, 2023.

### BACKGROUND

Image localization, also known as camera localization, is a process of determining a pose of a camera when the camera took a reference image. For example, an image localization system may determine GPS coordinates for a location at which an image was captured and the direction in which the camera was facing when it captured the image. Image localization systems may also determine the orientation and tilt of the camera to provide a complete six-degree-of-freedom pose estimate that fully describes the camera's position and viewing direction in three-dimensional space.

Image localization systems typically use one of two approaches. The first approach involves generating a 3D model of an area. Specifically, these systems may generate a 3D model of a geographical area based on a set of reference images. The system may compare a query image to the 3D model by performing an image matching process, and thereby determine a pose corresponding to the query image. The second approach is to train a bespoke machine-learning model for predicting an image's pose. This machine-learning model is trained based on a set of posed images within a target geographic area to ensure sufficient performance for that specific location.

However, these approaches have significant limitations in terms of generalization to challenging imaging conditions. Traditional 3D model-based systems may fail when query images are captured under different lighting conditions than the reference images, such as when mapping images are taken during daytime but query images are captured at night or during different seasons. Machine-learning models trained on specific datasets may struggle with substantial viewpoint changes, where query images are taken from significantly different angles or distances compared to the training images. These systems may also perform poorly when the physical scene has changed since the reference images were captured, such as when objects have been moved, renovations have occurred, or seasonal changes have altered the appearance of outdoor environments. The lack of robustness to these real-world variations limits the practical applicability of existing image localization systems, particularly for applications that need to operate reliably across diverse imaging conditions and over extended time periods.

### SUMMARY

A game server trains and uses a scene-agnostic coordinate model for image localization across multiple scenes. The game server accesses mapping buffers for a plurality of scenes, where each mapping buffer comprises feature-coordinate pairs that include feature vectors describing images, or patches of images, captured of corresponding scenes and coordinates of the images within the corresponding scenes. The game server initializes parameters for a scene-agnostic coordinate model and generates a plurality of scene-specific map codes, where each map code encodes features and coordinate information for a scene. The game server generates a map code for a scene by applying the scene-agnostic coordinate model to the map code and feature vectors to generate predicted coordinates, computing a map loss score by comparing predicted coordinates to actual coordinates, and updating the map code based on the map loss score. The game server may also update the scene-agnostic coordinate model based on the map loss score.

The game server accesses query buffers for each of the plurality of scenes, where each query buffer comprises a second plurality of feature-coordinate pairs. The game server trains the scene-agnostic coordinate model based on the query buffers by identifying map codes corresponding to feature-coordinate pairs, applying the scene-agnostic coordinate model to generate predicted coordinates, computing query loss scores, and updating parameters of the scene-agnostic coordinate model based on the query loss scores.

By training the coordinate model based on the query buffer separately from the training process for generating map codes, the coordinate model is scene-agnostic, meaning it can be used for many scenes for which map codes have been generated. The game server can thereby avoid training a scene-specific machine-learning model for each scene. Furthermore, because the coordinate model is scene agnostic, the game server can enable localization services within a new scene by simply generating new map codes, rather than building a new 3D model of the scene or training a new machine-learning model.

### BRIEF DESCRIPTION OF THE DRAWINGS

FIG. 1 is a conceptual diagram of a virtual world that parallels the real world.

FIG. 2 depicts one embodiment of a game interface that can be presented (e.g., on a player’s smartphone) as part of the interface between the player and the virtual world.

FIG. 3 illustrates one embodiment of a networked computing environment.

FIG. 4 is a flowchart for a method of training a scene-agnostic coordinate model, in accordance with some embodiments.

FIG. 5 illustrates an example data flow for generating map codes for a scene-agnostic coordinate model, in accordance with some embodiments.

FIG. 6 illustrates an example data flow for updating a scene-agnostic coordinate model based on a query buffer, in accordance with some embodiments.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where image localization is desirable. In addition, the inherent flexibility of computer-based systems allows for a great variety of possible configurations, combinations, and divisions of tasks and functionality between and among the components of the system.

### Example Location-Based Parallel Reality Game

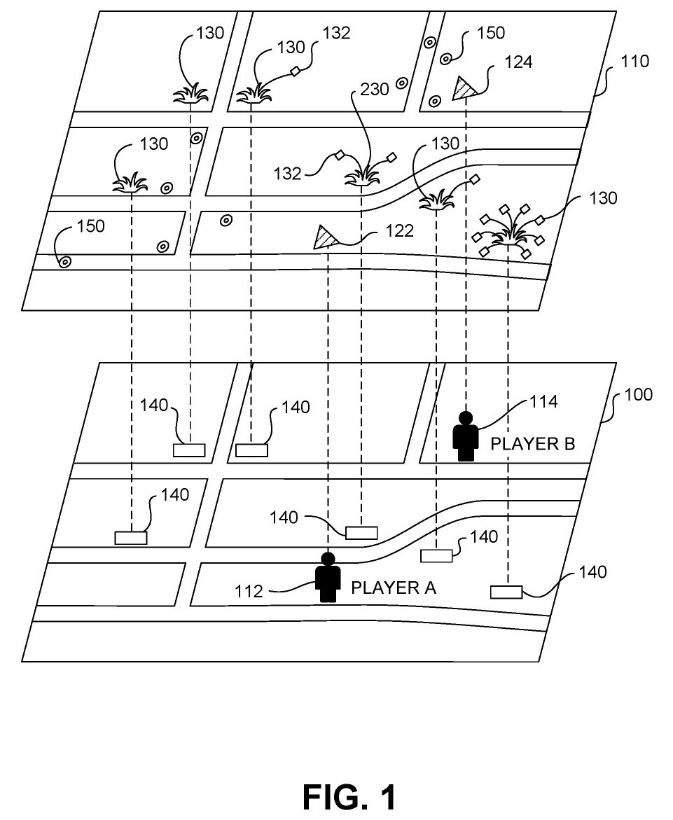

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player’s position in the virtual world 110 corresponds to the player’s position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player’s position as the player navigates the range of geographic coordinates in the real world 100. Data associated with the player’s position in the real world 100 is used to update the player’s position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game’s rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

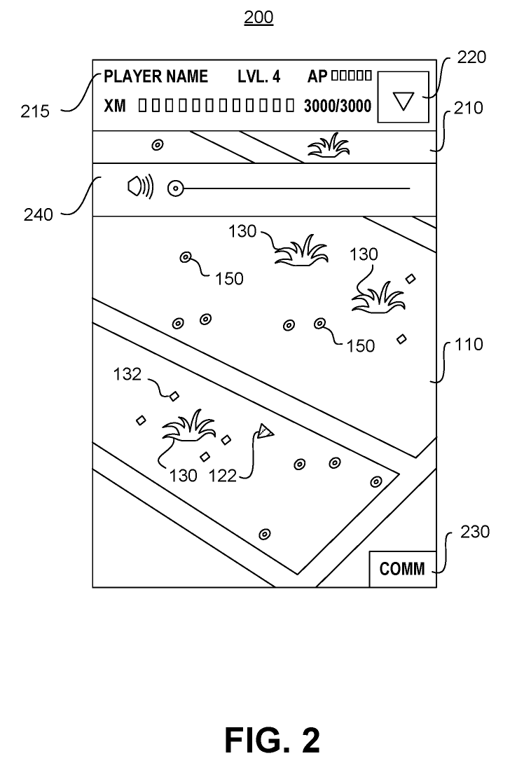

FIG. 2 depicts one embodiment of a game interface 200 that can be presented (e.g., on a player’s smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player’s proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

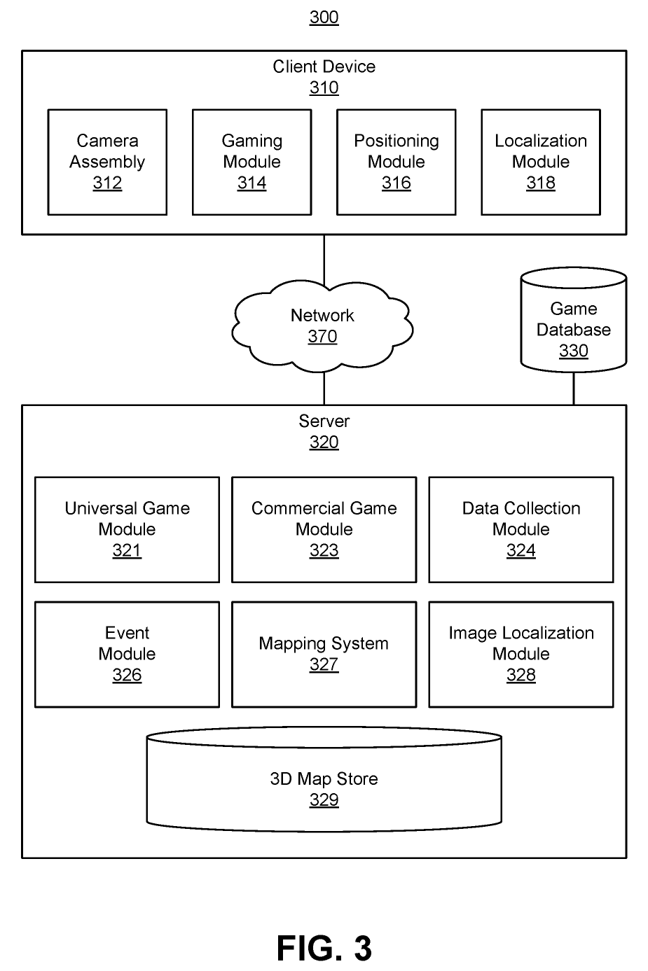

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player’s position in the real world can be tracked and used to update the player’s position in the virtual world. Typically, the player’s position in the real world is determined by finding the location of a client device 310 through which the player is interacting with the virtual world and assuming the player is at the same (or approximately the same) location. For example, in various embodiments, the player may interact with a virtual element if the player’s location in the real world is within a threshold distance (e.g., ten meters, twenty meters, etc.) of the real-world location that corresponds to the virtual location of the virtual element in the virtual world. For convenience, various embodiments are described with reference to “the player’s location” but one of skill in the art will appreciate that such references may refer to the location of the player’s client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, an image localization module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user’s identity may be treated so that no personally identifiable information can be determined for the user.

The image localization module 328 trains and uses a scene-agnostic coordinate model to localize a device based on its images. Additional details of an example embodiment are described below.

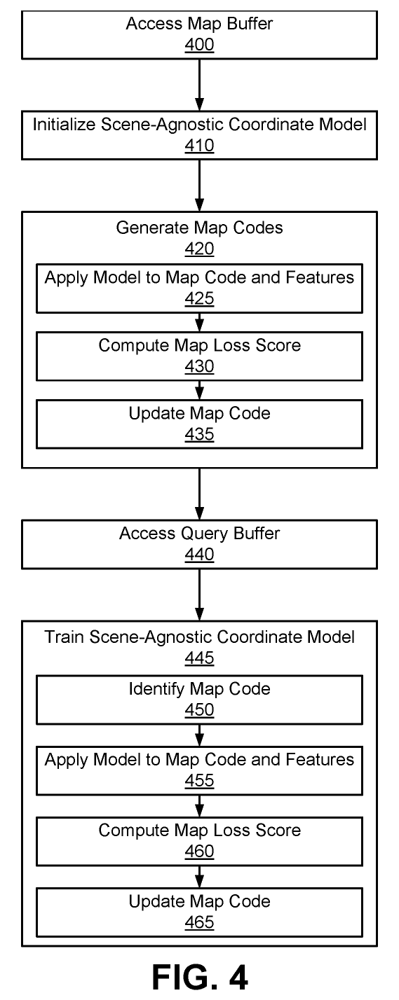

FIG. 4 is a flowchart for a method of training a scene-agnostic coordinate model, in accordance with some embodiments. Alternative embodiments may include more, fewer, or different steps from those illustrated in FIG. 4, and the steps may be performed in a different order from that illustrated in FIG. 4. Similarly, in some embodiments, certain steps may be performed more than once. These steps may be performed by a game server, a client device, or a combination of both. Additionally, each of these steps may be performed automatically by the game server without human intervention.

The game server accesses 400 a mapping buffer for each of a set of scenes. Scenes are areas in the physical world in which a game server may provide services. These scenes may correspond to points of interest such as parks, statues, buildings, museums, or other landmarks. Scenes may also include indoor environments such as rooms within buildings, shopping centers, airports, or train stations. Scenes may include outdoor areas such as city squares, courtyards, parking lots, or recreational facilities. Scenes may include user-designated areas such as specific rooms designated by a user for augmented reality experiences, custom boundaries defined around particular locations, or personalized zones created for specific gaming activities. Scenes may include transportation hubs such as subway platforms, bus terminals, or ferry docks. Scenes may include educational or cultural venues such as libraries, art galleries, theaters, or conference centers.

A mapping buffer is a dataset that contains information describing images captured within a scene. Specifically, the mapping buffer contains feature-coordinate pairs that describe the visual and spatial characteristics of the scene. Each feature-coordinate pair includes a set of features and coordinates that together describe an image captured within the scene. The features are visual characteristics that describe an image of the scene. These features may include edge information that identifies boundaries between different objects or regions in the image. The features may include color histograms that represent the distribution of colors within the image. The features may include texture descriptors that capture patterns and surface characteristics visible in the image. The features may include keypoint descriptors that identify distinctive visual landmarks within the image. The game server may generate these features by applying convolutional neural networks or transformers to the image that extract hierarchical visual representations. The game server may generate these features by applying feature extraction algorithms that identify distinctive visual patterns within the image. The game server may generate these features by computing statistical measures of pixel intensities and color distributions across the image.

In some embodiments, the set of features may be a feature vector. The feature vector may be a vector in a latent space that represents the image. The feature vector may encode the visual content of the image in a compressed numerical format that captures the essential visual characteristics needed for localization. In some embodiments, the feature vector comprises features that represent patches of the image. For example, each feature in the feature vector may represent a patch of the image.

The coordinates for a feature-coordinate pair are spatial coordinates that describe the location of a 3D surface visible within an image (or patch of an image) and/or the location at which the image (or patch of the image) was captured. The coordinates may be 3D coordinates that specify the location where the image was captured, such as x, y, and z values that define the position in three-dimensional space. Similarly, the coordinates may be 6D coordinates that specify both location and orientation. For example, the 6D coordinates may include three translational components and three rotational components that fully describe the camera pose when the image was captured.

The coordinates may be expressed in a reference frame that is relative to an origin point of the scene. The origin point may be established at a fixed location within the scene such as a corner of a building or a center point of the area. The coordinates may be measured as distances and angles from this origin point to provide a consistent spatial reference system for all images captured within the scene.

The game server initializes 410 a scene-agnostic coordinate model. A scene-agnostic coordinate model is a machine learning model that predicts coordinates within a scene at which an image is captured. The scene-agnostic coordinate model takes as input a map code for a scene and features for an image. The scene-agnostic coordinate model outputs predicted coordinates for where in the scene the image was captured. In some embodiments, the scene-agnostic coordinate model outputs 3D coordinates relative to images or image patches for the scene. The game server may then convert from the 3D coordinates to an overall pose for the image within the scene (e.g., using a random sample consensus (RANSAC) algorithm).

The scene-agnostic coordinate model may be a transformer model and may include attention mechanisms to process the input map code and image features. The transformer model may include multiple layers of self-attention and cross-attention blocks that enable the model to learn relationships between different parts of the input data. The transformer model may include encoder layers that process the image features and decoder layers that generate coordinate predictions based on the map code.

The game server generates 420 the set of map codes based on the mapping buffers. A map code is an encoding for feature and coordinate information for a scene. For example, the map code may be an embedding in a latent space that represents the spatial and visual characteristics of the scene in a compressed numerical format. The game server may generate multiple map codes for each scene. For example, each map code, when generated, may capture different aspects of the scene’s geometry and appearance.

The game server generates 420 the set of map codes based on the feature-coordinate pairs in the mapping buffers. Specifically, the game server uses the feature-coordinate pairs for a scene's mapping buffer to iteratively generate map codes for that scene. For example, for a feature-coordinate pair of a mapping buffer, the game server applies 425 the scene-agnostic coordinate model to the map code and the features of the feature-coordinate pair to generate predicted coordinates.

The game server computes 430 a map loss score by comparing the predicted coordinates to the coordinates from the feature-coordinate pair. The map loss score may be computed using a loss function that measures the difference between predicted and ground-truth coordinates. The game server computes a map loss score by comparing the predicted coordinates to the coordinates from the feature-coordinate pair. The map loss score may be computed using a loss function. For example, the game server may use such as mean squared error, mean absolute error, Huber loss, or negative log-likelihood loss functions.

The game server updates 435 the map code based on the map loss score. The game server may update the map code by computing gradients of the loss function with respect to the map code parameters. The game server may update the map code by applying gradient descent optimization that adjusts the map code values in the direction that reduces the loss score. The game server may update the map code by applying adaptive optimization algorithms such as Adam or AdamW that adjust learning rates based on historical gradient information. The values of the map code may change by small increments in directions that improve the model's ability to predict accurate coordinates for the scene.

The game server iterates through each feature-coordinate pair in the mapping buffer for a scene, updating the map code based on each pair. For each iteration, the game server applies the scene-agnostic coordinate model to the current map code and the feature vector of the feature-coordinate pair, computes the map loss score, and updates the map code based on the computed gradients. The game server may continue this iterative process until all feature-coordinate pairs in the mapping buffer for the scene have been processed. Once all pairs have been iterated through (or iterated through a certain number of times), the game server stores the final optimized map code for that scene. The game server may repeat this process for each scene in the plurality of scenes to generate the map codes for all scenes.

In some embodiments, the game server also updates parameters of the scene-agnostic coordinate model during the map code generation process. The game server may back propagate gradients through the scene-agnostic coordinate model to update both the model parameters and the map code in one pass. The back propagation process may compute gradients with respect to both the transformer weights and the map code values using the same loss function. The game server may alternate between updating the map code and updating the model parameters within each training iteration. The game server may update both the map code and model parameters jointly to optimize the overall coordinate prediction performance for each scene.

The game server accesses 440 a query buffer for each of the scenes. The query buffer may contain the same type of information as the mapping buffer, but with different actual data. For example, the query buffer may include feature-coordinate pairs that have the same structure and format as those in the mapping buffer. The game server may randomly assign feature-coordinate pairs between the mapping buffer and the query buffer for each scene. For example, the game server may assign the feature-coordinate pairs so that there is an equal amount of data in both the mapping buffer and the query buffer for each scene.

The game server trains 445 the scene-agnostic coordinate model based on the query buffers. Specifically, the game server uses the feature-coordinate pairs for a scene's query buffer to iteratively update the parameters of the scene-agnostic coordinate model. To train the scene-agnostic coordinate model based on a feature-coordinate pair, the game server identifies 450 which map code(s) correspond to the same scene as the pair and applies 455 the scene-agnostic coordinate model to the identified map code and features of the feature-coordinate pair to generate predicted coordinates. The game server computes 460 a query loss score by comparing the predicted coordinates to the coordinates from the feature-coordinate pair. The query loss score may be computed using similar loss functions as the map loss score. The game server updates 465 parameters of the scene-agnostic coordinate model based on the query loss score. In preferred embodiments, the game server updates the model parameters without updating the map codes during the query training process. By updating the model parameters without updating the map codes, the game server ensures that the model remains scene agnostic and can generalize to new scenes using different map codes.

The game server may generate additional map codes for new scenes that were not included in the original training process. For example, the game server may receive images and coordinates from a new scene and generate a mapping buffer and a query buffer from those images and coordinates. The game server may generate the map codes for the new scene by applying the same map training process described for the original scenes. During the map training process for new scenes, the game server may update only the map codes for the new scene without updating the parameters of the scene-agnostic coordinate model, thereby ensuring the model remains scene-agnostic.

The game server uses the trained scene-agnostic coordinate model to provide localization services to client devices. For example, the game server may receive an image from a client device that captures a view of a scene in which the client device is located. The game server receives scene information describing which scene the client device is located within. The scene information may be sensor data indicating the location of the client device. For example, the sensor data may include GPS data, accelerometer data, IMU data, or barometer data. Similarly, the scene information may be an indicator provided by a client application running on the client device. For example, the user may select their location through the client application by choosing from a list of available scenes or by tapping on a map interface that displays different scene options.

The game server generates features for the image received from the client device and identifies the map code(s) for the scene based on the received scene information. The game server applies the scene-agnostic coordinate model to the generated features and the identified map code to generate predicted coordinates for the image.

The game server may use the predicted coordinates to provide augmented reality content to the client device. The game server may generate augmented reality content based on the image and the predicted coordinates for the image. The game server may create virtual objects that are positioned at specific locations within the scene based on the predicted coordinates. The game server may generate virtual characters or items that appear to interact with real-world objects visible in the image. The game server may create visual overlays that highlight points of interest or provide information about locations within the scene. The game server may generate navigation aids such as directional arrows or path indicators that guide the user to specific destinations within the scene. The game server may transmit the augmented reality content to the client device along with positioning information that specifies how the virtual elements should be rendered relative to the captured image. The client device may display the augmented reality content by overlaying the virtual elements onto the real-world view captured by the device's camera.

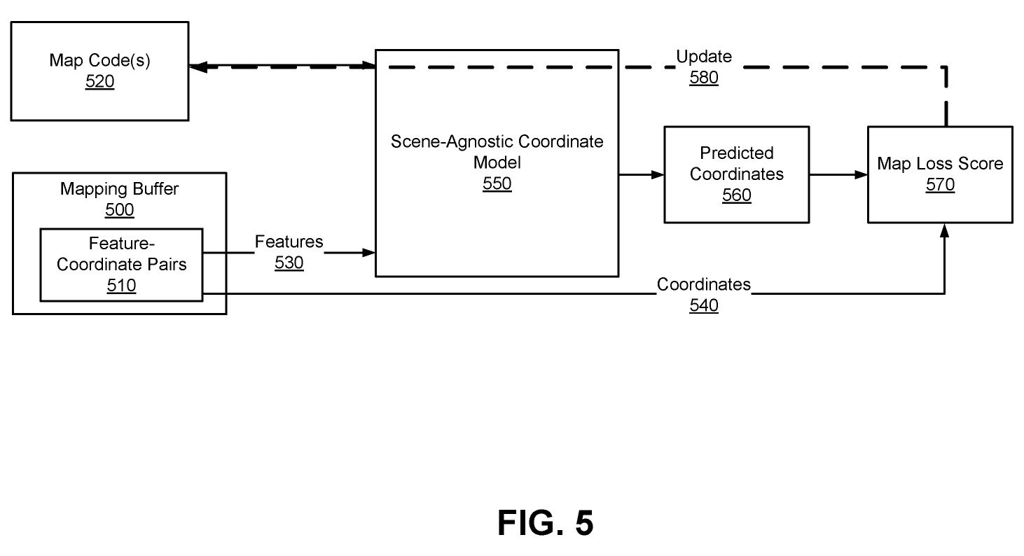

FIG. 5 illustrates an example data flow for generating map codes for a scene-agnostic coordinate model, in accordance with some embodiments. The game server uses a mapping buffer 500 with feature coordinate pairs 510 for a scene to generate map codes 520 for the scene. To generate the map codes, the game server inputs the map code(s) and features 530 from a feature-coordinate pair into the scene-agnostic coordinate model 550. The scene-agnostic coordinate model generates predicted coordinates 560 based on the input map code and features. The game server compares the predicted coordinates with coordinates 540 from the feature coordinate pair to compute a map loss score 570. The game server uses the map loss score 570 to update 580 the map code(s) 520 and, optionally, the scene-agnostic coordinate model.

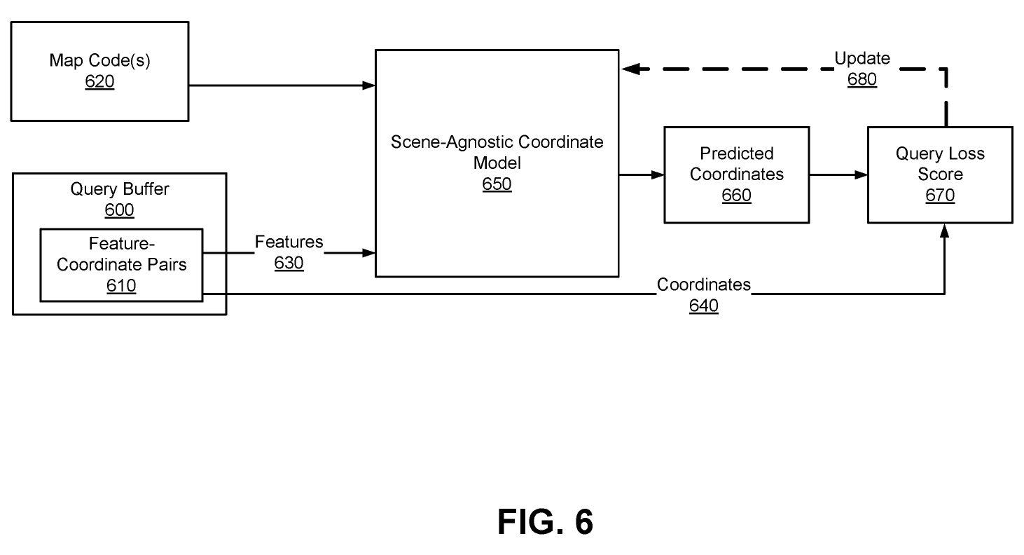

FIG. 6 illustrates an example data flow for updating a scene-agnostic coordinate model based on a query buffer, in accordance with some embodiments. The game server uses a query buffer 600 with feature coordinate pairs 610 to train the scene-agnostic coordinate model 650. The game server inputs the map code(s) 620 and features 630 from a feature coordinate pair into the scene-agnostic coordinate model 650. The scene-agnostic coordinate model generates predicted coordinates 660 based on the input map code and features. The game server compares the predicted coordinates with coordinates 640 from the feature coordinate pair to compute a query loss score 670. The game server uses the query loss score to update 680 the scene-agnostic coordinate model, and preferably without updating the map codes.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/- 10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing a mapping buffer for each of a plurality of scenes, wherein each mapping buffer comprises a first plurality of feature-coordinate pairs for a scene of the plurality of scenes, wherein each feature-coordinate pair comprises a set of features describing an image captured of a corresponding scene and coordinates of the image within the corresponding scene;
initializing parameters for a scene-agnostic coordinate model;
generating a plurality of map codes, wherein each of the plurality of map codes encodes feature and coordinate information for a scene of the plurality of scenes, wherein generating a map code for a scene comprises, for each feature-coordinate pair of the first plurality of feature-coordinate pairs for the scene:
applying the scene-agnostic coordinate model to the map code and the set of features of the feature-coordinate pair to generate predicted coordinates;
computing a map loss score by comparing the predicted coordinates to the coordinates of the feature-coordinate pair; and
updating the map code based on the map loss score;
accessing a query buffer for each of the plurality of scenes, wherein each query buffer comprises a second plurality of feature-coordinate pairs for the plurality of scenes; and
training the scene-agnostic coordinate model based on the query buffers, wherein training the scene-agnostic coordinate model based on a query buffer for a scene comprises, for each feature-coordinate pair of the second plurality of feature-coordinate pairs for the scene:
identifying a map code of the plurality of map codes for a scene of the plurality of scenes corresponding to the feature-coordinate pair;
applying the scene-agnostic coordinate model to the identified map code and the set of features of the feature-coordinate pair to generate predicted coordinates;
computing a query loss score by comparing the predicted coordinates to the coordinates of the feature-coordinate pair; and
updating the parameters of the scene-agnostic coordinate model based on the query loss score.

2. The method of claim 1, further comprising:
updating the parameters of the scene-agnostic coordinate model based on the map loss score.

3. The method of claim 1, further comprising generating the mapping buffer and the query buffer by:
receiving a plurality of images captured by a client device within a scene of the plurality of scenes;
receiving coordinates for each of the plurality of images;
generating a set of features for each of the plurality of images;
generating a plurality of feature-coordinate pairs for the plurality of images, wherein each of the plurality of feature coordinate pairs comprises the set of features for a corresponding image and the coordinates for the corresponding image; and
assigning each of the plurality of feature-coordinate pairs to one of the first plurality of feature-coordinate pairs or the second plurality of feature-coordinate pairs.

4. The method of claim 3, wherein receiving the coordinates comprises:
receiving sensor data captured by a sensor of the client device, wherein the sensor data comprises measurements captured when each of the plurality of images were captured.

5. The method of claim 1, wherein the scene-agnostic coordinate model is a transformer model.

6. The method of claim 1, wherein the coordinates for each feature-coordinate pair of the first plurality of feature-coordinate pairs and the second plurality of feature-coordinate pairs comprise three-dimensional coordinates describing a position within a corresponding scene of the plurality of scenes.

7. The method of claim 1, wherein computing the map loss score and the query loss score comprise applying a loss function to the predicted coordinates and the coordinates of the feature-coordinate pair.

8. The method of claim 7, wherein the loss function comprises a mean squared error function, a mean absolute error function, a Huber loss function, or a negative log-likelihood loss function.

9. The method of claim 1, further comprising:
receiving an image from a client device;
receiving scene information identifying a scene of the plurality of scenes within which the image was captured;
generating a set of features for the image;
identifying a map code for the scene based on the scene information;
applying the scene-agnostic coordinate model to the generated features and the identified map code to generate predicted coordinates for the image; and
providing augmented reality content to the client device based on the predicted coordinates.

10. The method of claim 1, wherein generating a plurality of map codes comprises:
generating a set of map codes for each scene of the plurality of scenes.

11. A non-transitory computer-readable medium storing computer-executable instructions that, when executed, cause a computing system to perform operations comprising:
accessing a mapping buffer for each of a plurality of scenes, wherein each mapping buffer comprises a first plurality of feature-coordinate pairs for a scene of the plurality of scenes, wherein each feature-coordinate pair comprises a set of features describing an image captured of a corresponding scene and coordinates of the image within the corresponding scene;
initializing parameters for a scene-agnostic coordinate model;
generating a plurality of map codes, wherein each of the plurality of map codes encodes feature and coordinate information for a scene of the plurality of scenes, wherein generating a map code for a scene comprises, for each feature-coordinate pair of the first plurality of feature-coordinate pairs for the scene:
applying the scene-agnostic coordinate model to the map code and the set of features of the feature-coordinate pair to generate predicted coordinates;
computing a map loss score by comparing the predicted coordinates to the coordinates of the feature-coordinate pair; and
updating the map code based on the map loss score;
accessing a query buffer for each of the plurality of scenes, wherein each query buffer comprises a second plurality of feature-coordinate pairs for the plurality of scenes; and
training the scene-agnostic coordinate model based on the query buffers, wherein training the scene-agnostic coordinate model based on a query buffer for a scene comprises, for each feature-coordinate pair of the second plurality of feature-coordinate pairs for the scene:
identifying a map code of the plurality of map codes for a scene of the plurality of scenes corresponding to the feature-coordinate pair;
applying the scene-agnostic coordinate model to the identified map code and the set of features of the feature-coordinate pair to generate predicted coordinates;
computing a query loss score by comparing the predicted coordinates to the coordinates of the feature-coordinate pair; and
updating the parameters of the scene-agnostic coordinate model based on the query loss score.

12. The method of claim 1, further comprising:
updating the parameters of the scene-agnostic coordinate model based on the map loss score.

13. The method of claim 1, further comprising generating the mapping buffer and the query buffer by:
receiving a plurality of images captured by a client device within a scene of the plurality of scenes;
receiving coordinates for each of the plurality of images;
generating a set of features for each of the plurality of images;
generating a plurality of feature-coordinate pairs for the plurality of images, wherein each of the plurality of feature coordinate pairs comprises the set of features for a corresponding image and the coordinates for the corresponding image; and
assigning each of the plurality of feature-coordinate pairs to one of the first plurality of feature-coordinate pairs or the second plurality of feature-coordinate pairs.

14. The method of claim 3, wherein receiving the coordinates comprises:
receiving sensor data captured by a sensor of the client device, wherein the sensor data comprises measurements captured when each of the plurality of images were captured.

15. The method of claim 1, wherein the scene-agnostic coordinate model is a transformer model.

16. The method of claim 1, wherein the coordinates for each feature-coordinate pair of the first plurality of feature-coordinate pairs and the second plurality of feature-coordinate pairs comprise three-dimensional coordinates describing a position and an orientation within a corresponding scene of the plurality of scenes.

17. The method of claim 1, wherein computing the map loss score and the query loss score comprise applying a loss function to the predicted coordinates and the coordinates of the feature-coordinate pair.

18. The method of claim 7, wherein the loss function comprises a mean squared error function, a mean absolute error function, a Huber loss function, or a negative log-likelihood loss function.

19. The method of claim 1, further comprising:
receiving an image from a client device;
receiving scene information identifying a scene of the plurality of scenes within which the image was captured;
generating a set of features for the image;
identifying a map code for the scene based on the scene information;
applying the scene-agnostic coordinate model to the generated features and the identified map code to generate predicted coordinates for the image; and
providing augmented reality content to the client device based on the predicted coordinates.

20. A computer-implemented method comprising:
receiving an image from a client device;
receiving scene information identifying a scene of the plurality of scenes within which the image was captured;
generating a set of features for the image;
identifying a map code of a plurality of map codes for the scene based on the scene information, wherein each of the plurality of map codes encodes feature and coordinate information for a scene of the plurality of scenes;
applying the scene-agnostic coordinate model to the generated features and the identified map code to generate predicted coordinates for the image, wherein the scene-agnostic coordinate model is a transformer model that is trained to generate predicted coordinates within scenes for images based on input features for the images and map codes for the scenes; and
providing augmented reality content to the client device based on the predicted coordinates.
